(19) United States
(12) Patent Application Publication
(10) Pub. No.: US 2017/0132729 A1
(43) Pub. Date: May 11, 2017

(54) REAL ESTATE BUSINESS METHOD AND APPARATUS

(71) Applicants: Stacey Spencer, Finksburg, MD (US); Eric Spencer, Finksburg, MD (US)

(72) Inventors: Stacey Spencer, Finksburg, MD (US); Eric Spencer, Finksburg, MD (US)

(21) Appl. No.: 14/934,847

(22) Filed: Nov. 6, 2015

(51) Int. Cl. G06Q 50/16; H04W 4/02; H04L 29/08; G06Q 30/06; G06Q 20/32

(52) U.S. Cl. CPC G06Q 50/167; G06Q 30/0641; G06Q 20/322; H04L 67/02; H04W 4/021

(57) ABSTRACT

A real estate business method and apparatus is comprised of a wireless transmitter that is affixed to a real estate sign or in the property itself that transmits a serial number or a URL/web site address that has been associated with the given property that allows a potential buyer to quickly and easily obtain detailed information concerning the property using their mobile device. The URL may be reconfigured by the real estate agent using a web based tool or a mobile app.

### CROSS-REFERENCE TO RELATED APPLICATIONS

This claims the benefit of and priority from U.S. Provisional Patent Application Ser. No. 62/202,979, filed Aug. 10, 2015 which is hereby incorporated by reference in their entirety for all purposes.

### BACKGROUND

The current method of marketing real estate property for sale is labor intensive and necessarily results in significant variation in the quality and timeliness of information transfer between the property seller, the seller's agent and the prospective buyers.

“For Sale By Owner” and other methods of selling real estate which do not involve formal and substantive real estate agent involvement are susceptible to significant confusion, lost time, legal and other difficulties inherent in satisfactory execution of a sale. Such methods can potentially expose both the seller and the buyer to significant risks and legal liabilities.

Traditional real estate signs serve only to direct prospective buyers to a single real estate office or agent. Such “For Sale” properties can only be investigated during certain (e.g., daylight, agency office, etc.) hours and such appointments must most often be scheduled ahead of time through the buyer's agent and/or the property occupants. This is especially problematical when property offered for sale is unoccupied, located in rural areas, or is otherwise distant or requires significant travel time from the listing real estate office.

Often potential buyers will come across a “For Sale” sign on a property and have no way of determining the particulars of a property without either attempting to locate the property in an internet listing which requires the potential buyer to search for the property on the internet or contact the listing agent to request the information, which can be time consuming and frustrating.

There therefore needs to be an easier way for a prospective buyer to quickly and easily retrieve detailed information associated with a particular property that does not require the buyer to contact a seller's agent or the seller and does not require the potential buyer to search on the internet for the property. Systems do currently exist that allow the potential buyer to scan a QR code found on the for sale sign or manually enter a URL into their mobile device to find the details of a given property, but again, this requires the potential buyer to manually type in the URL into a browser located on their mobile device, or get out of their car to get close enough to the sign to scan the QR code.

There have been attempts at providing “smart” real estate signs which wirelessly transmit data. For example, U.S. Pat. No. 6,624,742 to Romano et al., incorporated herein by reference, discloses an intelligent real estate sign, but this invention uses an expensive and power intensive communications device that must transmit and receive wirelessly a large amount of data. Similarly, US Patent Application No. 2006/02601161to Hamilton, incorporated herein by reference, discloses an illuminated sign that may also include a wireless transmitter for the transmission of data related to the sale of real estate. But in this invention the transmitter would store and transmit a large amount of data that includes the detailed information associated with a piece of real estate. Storage and transmission of this data on the transmitter would require the use of a large amount of memory on the transmitter as well as a lot of power. Further, this invention does not take advantage of a mobile device's ability to obtain data over a wireless network but instead requires the transmitter to store and transmit the large amount of data.

The invention described herein transmits a simple wireless signal that identifies the serial number or a URL associated with the wireless transmitter, such as a Bluetooth or wifi signal, to the potential buyer's mobile device or computer, the unique serial number may configurable to be associated with a URL that correlates to a web page/site that provides all the specifics of the property. The wireless signal is provided by a small wireless transmitter that is affixed to the For Sale sign or is located in the property. The wireless transmitter is configured to transmit the signal to a potential buyer's mobile device and will cause an alert/notification to show up on the mobile device as a potential buyer approaches the vicinity of the For Sale sign or the property. The potential buyer may chose to ignore the alert/notification or open the alert which will bring the potential buyer immediately to the web page/site associated with the given property.

### BRIEF DESCRIPTION OF THE DRAWINGS

Embodiments will be described with reference to the following drawing figures, in which like numerals represent like items throughout the figures, and in which:

FIG. 1 is a diagram of the real estate business method and apparatus with an example embodiment of the invention.

FIG. 2 is a diagram of a flow diagram of an exemplicative embodiment of the real estate business method and apparatus.

### DETAILED DESCRIPTION

The present invention is described with reference to the attached figures. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operation are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is if, X employs A; X employs B; or X employs both A and B, then “X employs A or B” is satisfied under any of the foregoing instances.

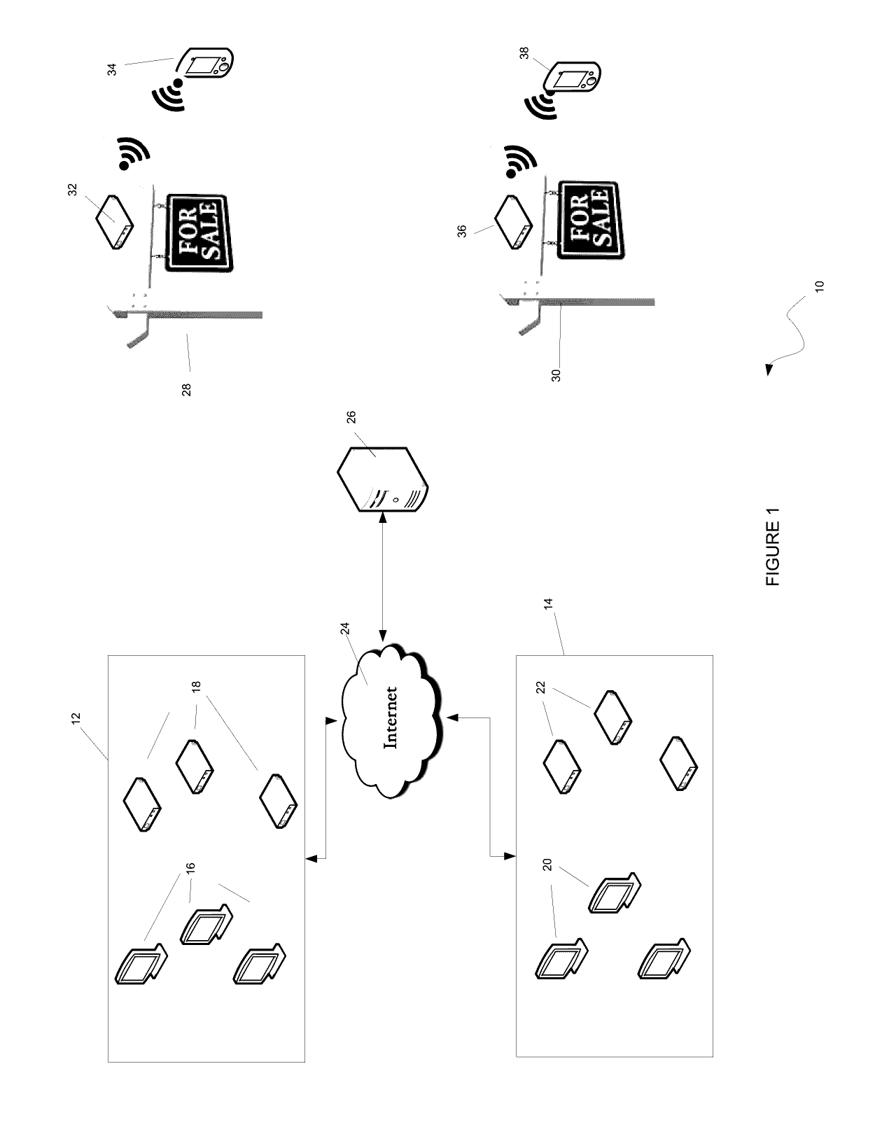

Referring now to FIG. 1, a real estate business method and apparatus 10 is generally shown in accordance with an exemplicative embodiment. The real estate business method and apparatus will be described in the context of multiple and unrelated real estate offices which usually employ more than one real estate agent. In this context, and for illustration purposes only, it is assumed each real estate office manages and controls the use of the invention described herein. This context should not be construed as a limitation to the invention and is only provided to illustrate one embodiment of the invention disclosed herein.

A plurality of real estate offices 12 and 14 each are comprised of a network of computing devices 16 and 20 respectively which are connected to a central server 26 through the internet 24 or any other network connection. Wireless transmitters 18 and 22 respectively may be either purchased or leased by the respective real estate office. The wireless transmitters 18 and 22 are relatively small electronic devices that are managed and controlled by the respective real estate office and the realtors associated with the real estate office. Each wireless transmitter is uniquely identifiable by a serial number or the like and along with other information, may be configured to transmit a wireless signal that identifies a that unique serial number which has been associated with a URL that is associated with a given real estate listing. The transmitter may also be configured to transmit a URL instead of a serial number. A URL is a Uniform Resource Locator which could be for example a web site address, video file, audio file, etc. For example, a wireless transmitter may have a serial number associated with the device, and the URL associated with that particular device may be configured and reconfigured by a real estate agent to provide the URL of a selected real estate property. The real estate agent would then either attach the wireless transmitter (shown as 32 and 36) to the For Sale sign that is associated with the selected property or may attach/plug in the wireless transmitter in the property itself.

As mentioned previously, the wireless transmitter is configured to emit a wireless signal (Bluetooth/WiFi/3G/4G/5G/WiMax/infrared, etc.) that is received by a potential buyer's mobile device, shown as items 34 and 38, which provides the URL that was associated with the wireless transmitter by the real estate agent. Preferably the signal would be Bluetooth 4.0 Low Energy which provides unique low power signal capabilities and would allow the transmitter to run off of battery power for months or even years.

The wireless transmitter 18 and 22 may only be able to transmit and not be able to receive. The signal transmitted by the wireless transmitter is either the unique serial number assigned to the wireless transmitter or the URL associated with the property. Data transmitted by the wireless transmitter is intermittently broadcast to reduce power consumption. In a preferred embodiment, the transmission could occur every 100 ms to every 5s. By transmitting at such long intervals just the serial number or the URL, the transmitter uses very little power. The potential buyer would receive an alert/notification on their mobile device which would allow the potential buyer to immediately go to the URL and obtain detailed information about the selected property. In the case of a transmitted serial number, the mobile device is able to communicate over a mobile network to a database which correlates the serial number of the transmitter to determine the URL associated with that specific transmitter. In the case of a transmitted URL, the mobile device is able to connected to the URL over the mobile network. The user's mobile device is then able to retrieve the URL that is associated with the transmitter. The wireless transmitter, in a preferred embodiment, would use either a Bluetooth or Wifi compliant signal which is available on all modern mobile devices. In the event of multiple properties, a potential buyer may receive multiple alerts/notifications at the same time from multiple transmitters, and the potential buyer could select which property URL to view.

It should be mentioned that in one exemplicative embodiment, the wireless transmitter is configured to only transmit and has no ability to receive. If the wireless transmitter is battery powered, it may also be advantageous for the wireless transmitter to transmit a signal which provides the battery status of the wireless transmitter so the real estate agent may replace the battery before the power runs out. It may also be preferably to use solar power to power the wireless transmitter.

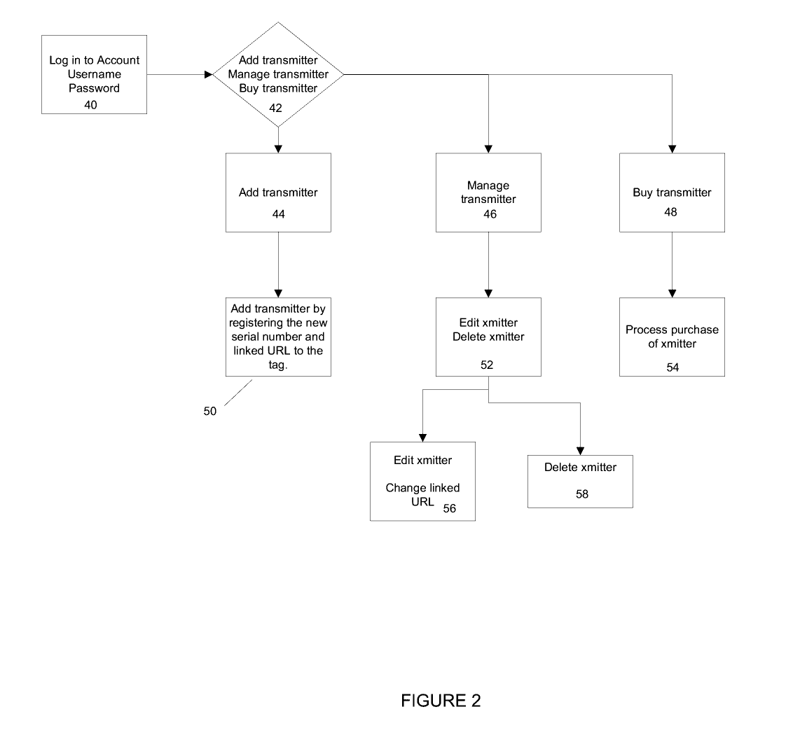

Referring now to FIG. 2, the steps associated with the programming and management of the wireless transmitters will now be described in accordance with an exemplicative embodiment of the invention. Keeping with the context of a plurality of real estate offices, each office managing its own supply of wireless transmitters, a real estate agent may log into the server 26 at box 40. This typically will require the agent to have already established an account with a unique username and password. Once log into the system, at box 42, the agent will have three options 1—Add a wireless transmitter to their account; 2—Manage a wireless transmitter that is already associated with their account, or; 3—Buy/lease a new wireless transmitter.

If the agent decides to add a wireless transmitter to their account, as shown in box 44 and 50, the system will provide the necessary steps to register a wireless transmitter to the agent's account by registering the wireless transmitter's serial number with the agent's account. It may be advantageous that a wireless transmitter may not be managed by an agent unless it is registered with the agent's account.

If the agent decides to manage a wireless transmitter as shown in box 46, the agent will be shown a listing by serial number of the wireless transmitters already registered with their account. At box 52, the agent may either edit a wireless transmitter or delete a wireless transmitter from their account. If the agent decides to edit the wireless transmitter as shown in box 56, the agent would select a specific transmitter by serial number and then may enter the URL that is associated with the selected wireless transmitter. Once completed, the URL will be assigned to or in some other form related to the transmitter so that its signal will identify the URL selected by the agent. If the agent decides to delete the transmitter as shown in box 56, the agent will select the transmitter by serial number and delete the transmitter from the agent's account. This provides a means for an agent to remove a transmitter from their account so that another agent may take control of the transmitter if so desired.

If an agent decides to buy a new transmitter, as shown in box 48, the process of ordering and paying for a new transmitter may be accomplished in box 54. The transmitter will be delivered to the agent and the agent will need to add the transmitter to their account as described previously.

It should be mentioned that it may be preferable to provide a mobile phone app that allows an agent to manage their account and the transmitters while they are out in the field. That capability is fully contemplated by the invention described herein where the functionality described in FIG. 2 could be provided by a mobile phone app.

It should also be mentioned that changing the URL associated with a given wireless transmitter may also be accomplished without needing to be near the wireless transmitter. Since the serial number that is transmitted by the wireless transmitter may never change, all that needs to be changed is the URL associated with the transmitter's serial number, which may be accomplished using the web based configuration tool.

What is claimed is:

1. A wireless transmitter disposed adjacent a predetermined piece of real estate, said transmitter configured to emit a wireless signal to identify said wireless transmitter, said signal being received by a mobile device that allows the mobile device to determine a URL associated with the piece of real estate.

2. The wireless transmitter of claim 1, wherein said signal is one selected from the group consisting of Wifi, Bluetooth, 3G, WiMax, 4G, 5G and infrared.

3. The wireless transmitter of claim 2, wherein said Bluetooth signal is a Bluetooth 4.0 Low Energy compliant signal.

4. The wireless transmitter of claim 1, wherein said transmitter is disposed on a sign associated with the predetermined piece of real estate.

5. The wireless transmitter of claim 1, wherein said transmitter is solar powered.

6. The wireless transmitter of claim 1, wherein said transmitter is plugged into an electrical outlet adjacent the predetermined piece of real estate.

7. The wireless transmitter of claim 1, wherein said URL associated with said wireless transmitter may be modified using a web based configuration software program.

8. The wireless transmitter of claim 1, wherein said URL associated with said wireless transmitter may be modified using a mobile phone application.

9. The wireless transmitter of claim 1, wherein receipt of said signal by said mobile device causes a notification to be presented to the user of the mobile device.

10. The wireless transmitter of claim 9, wherein said notification allows the user to select the notification for display of a web page associated with said URL.

11. The wireless transmitter of claim 1, wherein said mobile device is configured to run an Android or Apple iOS application.

12. The wireless transmitter of claim 1, wherein said URL may be selected from the group consisting of a web site address, a video file, an image file and an audio file.

13. A method, comprising:
a. configuring a wireless transmitter to emit a signal at a predetermined interval that identifies a URL associated with the wireless transmitter;
b. associating said URL with information related to a predetermined piece of real estate; and,
c. disposing said wireless transmitter adjacent the predetermined piece of real estate.

14. The method of claim 13, further comprising the steps of:
a. displaying a notification on a mobile device when said mobile device receives said wireless signal from said wireless transmitter;
b. in response to a user selecting said notification, said mobile device communicates wirelessly with the internet to retrieve said information associated with said URL; and,
c. displaying said information on the screen of said mobile device.

15. The method of claim 13, wherein the step of configuring a wireless transmitter to emit a signal that is associated with a URL, further comprises the steps of:
a. retrieving the unique serial number assigned to said wireless transmitter;
b. recording said serial number in a computer database;
c. associating a URL to said serial number; and
d. recording the URL associated with said serial number in said computer database.

16. The method of claim 15, wherein said computer database is networked and configured to allow for multiple users from multiple organizations over a large geographic area.

17. The method of claim 16, further comprising the steps of:
a. obtaining said wireless transmitter from a service provider; and,
b. using a web based software tool, associating said wireless transmitter with a user account.

18. The method of claim 13, wherein the step of associating said URL with information related to a predetermined piece of real estate is performed using a web based software tool.

19. The method of claim 13, wherein the step of associating said URL with information related to a predetermined piece of real estate is performed using a mobile device.

20. The method of claim 13, wherein said predetermined interval is between 100 milliseconds and 5 seconds.
